(19) United States
(12) Patent Application Publication
(10) Pub. No.: US 2002/0133404 A1
(43) Pub. Date: Sep. 19, 2002

(54) Internet advertisements having personalized context

(76) Inventor: Brad D. Pedersen, Minneapolis, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 09/812,253

(22) Filed: Mar. 19, 2001

(51) Int. Cl. G06F 17/60

(52) U.S. Cl. 705/14

(57) ABSTRACT

A system for customizing the context of advertisements for communication to users on the Internet develops a profile for a given user that includes at least archetype identification information for the given user. An Internet advertisement is obtained in a conventional manner from an advertisement database, but prior to communicating that advertisement to the user the context of the advertisement is altered based on the archetype identification information in the profile of the given user. The context elements of the advertisement that may be altered include the color, texture, font, background, voice, pacing, or any combination of these context elements. The archetype identification information in the profile is developed based on an analysis of a context of interactions of a given user with a website on which the advertisement is to be displayed. The context of interactions for the user may include timing of responses, patterns of access and response parametrics about how the user interacts with the website that are separate from information the user has supplied to or requested from the website. The objective is to allow the same content of an Internet advertisement to be more persuasively packaged in different contexts for different archetypes of users.

### FIELD OF THE INVENTION

The present invention relates generally to the field of customization of communications over a networked computer system. More specifically, the present invention relates to a method and apparatus for providing Internet advertisements having personalized context.

### BACKGROUND OF THE INVENTION

Customization and personalization of information content over the Internet has become increasingly popular. Internet websites and advertisers have incorporated personalization as an important part of the way information and, particularly, advertisements are communicated to users. Such personalization is one of the most unique features of the Internet in terms of an advertising medium. Most often, the process of personalizing advertisements is based on demographic information directly provided by users, collaborative filtering of information gathered from the interactions of a user with a website, behavior prediction techniques, expert suitability ratings, or some combination of these techniques. Examples of collaborative filtering techniques for customizing Internet advertising can be found in U.S. Pat. Nos. 5,704,017, 5,717,923, 5,790,426, 5,884,282, 5,918,014, and 6,009,410. Examples of user profiling to target information or advertising can be found in U.S. Pat. Nos. 5,761,662, 5,854,923, 5,848,396, 5,867,799, 5,991,735 and 5,999,975. Examples of behavior prediction techniques can be found in U.S. Pat. Nos. 4,870,579, 5,710,884 and 5,848,396. Examples of expert suitability rating and recommendation techniques that recommend products to users can be found in U.S. Pat. Nos. 4,996,642, 5,550,746, 5,583,763, 5,749,081, 5,754,938, 5,768,142 and 5,978,766. Examples of companies offering personalization software and services can be found at doubleclick.com, netperceptions.com, netmind.com, kanisa.com, cluetrain.com and personalization.com.

Personalization in terms of the way in which that information is presented to a user by the graphical user interfaces (GUIs) of various Internet applications is becoming more popular. The look and feel of Internet browsers, for example, are now customizable to the tastes and preferences of an individual user by applying different “skins” to the GUI. These skins are overlays that typically modify the graphic features of the web browser so as to present a more pleasing appearance to the standard browser GUI. Skins are also popular with the GUIs of music and audiovisual players that download content over the Internet. In each case, however, the choice of what “skin” will be used for a GUI is a choice made by the individual user.

The concept of personality testing to establish characteristic traits of an individual is well known. The well-known archetype personality types of sanguine, phlegmatic, choleric and melancholic, for example, date back to Hippocrates. Many different systems have been developed over the years based on these four fundamental personality archetypes. The popular fashion types of spring, summer, fall and winter are based on these four archetypes. There is also a strong correlation between these archetypes and the personality types of the Meyers-Briggs profiles. U.S. Pat. Nos. 5,696,981, 5,702,253, 5,871,211 describe various types of personality testing techniques using flash cards or game settings. U.S. Pat. No. 5,542,849 describes a personality self-testing system by having a user choose among different shaped stimuli that are not known by the user to have a relation to personality types. While this type of personality testing could provide useful profile information about users, these tests are not easily adaptable to an Internet environment and would involve a willingness of the user to devote significant time and disclosure to provide useful information.

Although it is well known that different people respond differently to different types of messages and advertisements, the current focus of customization and personalization of Internet advertisement has been on the identifying the preferences of users in terms of the content of such advertisement. It would be desirable to provide a system for customizing Internet advertisements that could make the appearance and appeal of Internet advertisements more personalized to users.

### SUMMARY OF THE INVENTION

The present invention customizes the context of advertisements for communication to users on the Internet by developing a profile for a given user that includes at least archetype identification information for the given user. An Internet advertisement is obtained in a conventional manner from an advertisement database, but prior to communicating that advertisement to the user the context of the advertisement is altered based on the archetype identification information in the profile of the given user. The context elements of the advertisement that may be altered include the color, texture, font, background, voice, pacing, or any combination of these context elements. The archetype identification information in the profile is developed based on an analysis of a context of interactions of a given user, preferably with a website on which the advertisement is to be displayed. The context of interactions for the user may include timing of responses, patterns of access and response parametrics about how the user interacts with the website that preferably are separate from information the user has supplied to or requested from the website. The objective of the present invention is to allow the same content of an Internet advertisement to be more persuasively packaged in different contexts for different archetypes of users.

In a preferred embodiment, the archetype identification information categorizes a user into one of four primary archetype classes: sanguine, phlegmatic, choleric or melancholic. The analysis of the context of interactions of a given user with a website will tend to highlight one primary archetype class based on how that user interacts with a website. For example, the interactions of a user typed as sanguine would tend to reflect a lighter, playful almost sporadic pattern of interactions. Factoring out network delays to normalize the timing of responses, the timing of a sanguine user's interactions with a website most often would be highly variable with a tendency to explore new areas. The interactions of a user typed as a phlegmatic, on the other hand, would tend to reflect a slower, and more reflective pattern of interactions. The normalized timing of a phlegmatic user's interactions with a website would be slower with some variability and with a tendency to more thoroughly investigate a line of inquiry. The interactions of a user typed as choleric would tend to reflect a very quick and decisive pattern of interactions. The normalized timing of a choleric user's interactions with would be quicker with a tendency toward impatience in moving through material once a decision has been made. The interactions of a user types as melancholic would tend to reflect a more constant and deliberative pattern of interactions. The normalized timing of a melancholic user's interactions would be more constantly paced with smaller variability and a tendency to seek out perfection in the interaction.

Once an archetype identification is made for a user, the context of advertisements can be altered to make those advertisements more appealing for that type of user. For example, if the user is typed as a sanguine, then brighter and lighter colors, fonts and textures are more appealing. A quicker pacing of the presentation of information is preferred as a sanguine user will be more attracted to an almost lyrical style of presentation. If the user is typed as a phlegmatic, then softer and more blended colors, fonts and textures should be used. A slower and more seamless pacing of the presentation of information is preferred as a phlegmatic user will be more attracted to a smooth and flowing style of presentation. If the user is typed as a choleric, then earth tone colors with more angular fonts and textures should be used. A quick and decisive pacing of the presentation of information is preferred as a choleric user will be more attracted to a very efficient style of presentation. If the user is typed as a melancholic, then jewel tone colors with more bold and contrasting fonts and textures should be used. A deliberate and constant pacing of the presentation of information is preferred as a melancholic user will be more attracted to a symmetrical style of presentation.

By altering the context of Internet advertisements, the present invention allows the very same content to be presented in a more appealing manner to different types of users, even though those users would otherwise be categorized as having the same preferences based on conventional personalization or customization techniques.

### BRIEF DESCRIPTION OF THE DRAWINGS

FIG. 1 is a block diagram of an existing personalization system for customizing the delivery of Internet advertisements.

FIG. 2 is a block diagram of a context customization system for altering the context of advertisement delivered over the Internet in accordance with the present invention.

### DETAILED DESCRIPTION OF THE PREFERRED EMBODIMENT

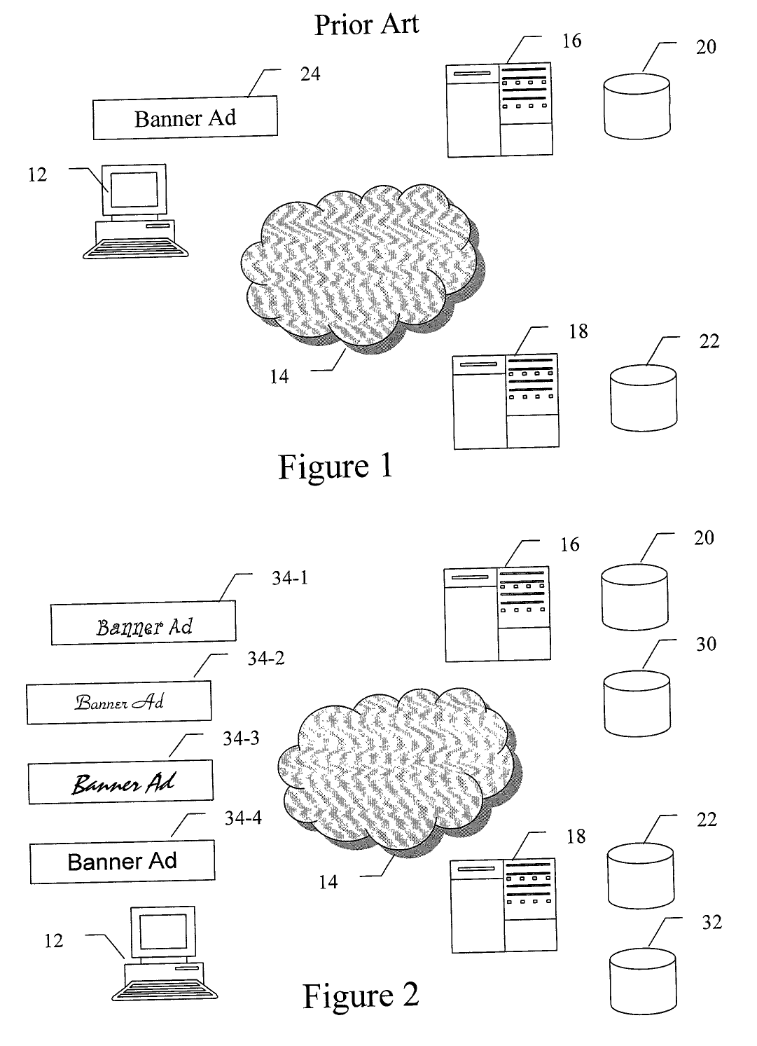

Referring to FIG. 1, the existing process of delivering a banner ad 24 to a computer user 12 connected to the Internet 14 will be described. When the user 12 accesses a web site provided by a web site server 16, content for that web site is delivered from a web site content database 20. For any banner ads that are to be displayed along with the web site, the server 16 sends a request to an ad server 18 requesting a banner ad maintained in a banner ad database 22. A banner ad 24 is then delivered over the Internet 14 along with the web site content to generate a web page for display at the computer user 12. It should be understood that conventional content personalization techniques are applied by either the web site server 16, the ad server 18, or even a third server for the purposes of selecting an ad to be displayed based on direct input or gathered demographic or individual data about the computer user 12.

Referring now to FIG. 2, the process of delivering a context customized banner ad 34 in accordance with the present invention will be described. The user 12 accesses a web site provided by a web site server 16 from a web site content database 20. In one embodiment, the web site server 16 collects personalization data in an archetype identification database 30. The archetype identification database 30 may be maintained as part of, or separate from, a personalization database that would include direct responses from the user, expressed and determined preferences and demographic or identification information used for selecting an advertisement. Preferably, the archetype identification information is collected in an archetype profile file stored in the archetype identification database 30 for each user accessing the web site pages supported by web server 16. The archetype profile is developed based on an analysis of a context of interactions of a given user. The context of interactions for the user may include timing of responses, patterns of access and response parametrics about how the user interacts with the website that preferably are separate from information the user has supplied to or requested from the website. Alternatively, the archetype profile may be determined in whole or in part from information supplied by the user or information deduced by personalization techniques. Any of a variety of known methods created for use by conventional personalization techniques may be used to correlate profile information developed during a single web session, over multiple web sessions or even across multiple web sites with a given user.

In a preferred embodiment, the archetype identification information categorizes the archetype profile of a user 12 as one of four primary archetype classes: sanguine, phlegmatic, choleric or melancholic. The analysis of the context of interactions of the user 12 with the website 16, for example, will tend to highlight one primary archetype class based on how that user interacts with a website. For example, the interactions of a user typed as sanguine would tend to reflect a lighter, playful almost sporadic pattern of interactions. Factoring out network delays to normalize the timing of responses, the timing of a sanguine user's interactions with a website most often would be highly variable with a tendency to explore new areas. The interactions of a user typed as a phlegmatic, on the other hand, would tend to reflect a slower, and more reflective pattern of interactions. The normalized timing of a phlegmatic user's interactions with a website would be slower with some variability and with a tendency to more thoroughly investigate a line of inquiry. The interactions of a user typed as choleric would tend to reflect a very quick and decisive pattern of interactions. The normalized timing of a choleric user's interactions with would be quicker with a tendency toward impatience in moving through material once a decision has been made. The interactions of a user types as melancholic would tend to reflect a more constant and deliberative pattern of interactions. The normalized timing of a melancholic user's interactions would be more constantly paced with smaller variability and a tendency to seek out perfection in the interaction. Just as conventional personalization software tracks response of a given user across visits and/or websites to compile a profile of preferences and interests, the archetype identification information also preferably tracks the patterns of user interactions across visits and/or web sites. Although the preferred embodiment of the present invention has been described in terms of four archetypes, it will be understood that further differentiation can create additional categories or subcategories of combinations of these four archetypes. Alternatively, other typing schemes such as the five Chinese types could be used as the basis for determining the archetype profile information for a given user.

Instead of requesting a banner ad, for example, at random or based on the results of a personalization technique, the server 16 requests a banner ad 34 and supplies profile information to the ad server 18. In one embodiment, the profile information from the archetype profile database 30 is used to indicate which of four different contexts should be used to display the banner ad 34. This information is communicated to the ad server 18 as part of a request for an advertisement to be displayed to the computer user. The ad server 18 uses the profile information to identify which of the four contexts 34-1, 34-2, 34-3 or 34-4 should be used to display the content of the ad 34. It should be noted that the content of the ad 34 remains substantially the same regardless of which of the four contexts is utilized.

The context of the ads 34 are altered to make those advertisements more appealing for a given archetype profile identified for that user. For example, if the user is typed as a sanguine, then brighter and lighter colors, fonts and textures are more appealing as shown in ad 34-1. If the user is typed as a phlegmatic, then softer and more blended colors, fonts and textures should be used as shown in ad 34-2. If the user is typed as a choleric, then earth tone colors with more angular fonts and textures should be used as shown in ad 34-3. If the user is typed as a melancholic, then jewel tone colors with more bold and contrasting fonts and textures should be used as shown in ad 34-4. In one embodiment, information about how to alter the context of the ad 34 is contained in a context database 32 that is indexed by the profile type. In this embodiment, for example, a different font type and possibly a different background design and/or color would be specified for each different profile type. In another embodiment, the ad database 22 and context database 32 could be integrated in that four different context versions of the same content ad could be stored and selectively displayed in response to the profile information provided as part of an ad request.

The pacing and timing of the presentation of the context of the ad 34 can also be altered and/or controlled by the profile information. For example, the pacing of how often ads 34 are rotated in a banner ad window can be determined by the profile information. A quicker pacing of the presentation of information is preferred as a sanguine user will be more attracted to an almost lyrical style of presentation for ads 34-1. A slower and more seamless pacing of the presentation of information is preferred as a phlegmatic user will be more attracted to a smooth and flowing style of presentation for ads 34-2. A quick and decisive pacing of the presentation of information is preferred as a choleric user will be more attracted to a very efficient style of presentation for ads 34-3. A deliberate and constant pacing of the presentation of information is preferred as a melancholic user will be more attracted to a symmetrical style of presentation for ads 34-4.

In an alternate embodiment, the identification of archetype profile information is maintained by the ad server 18, instead of by the web server 16. In this embodiment, the identification of an archetype profile is preferably derived from demographic information and personalization information developed in connection with a given user based on accesses across multiple web sites. Preferably, this information is supplemented by having these multiple web sites collect some of the pattern and timing information as has been previously described about interactions of a given user with the web site 16 and then forwarding this information to the ad server 18.

Although the preferred embodiment of the automated system of the present invention has been described, it will be recognized that numerous changes and variations can be made and that the scope of the present invention is intended to be defined by the claims.

1. A computer-implemented method of customizing the context of advertisements for communication to users on the Internet comprising:
developing a profile for a given user, the profile including at least archetype identification information for the given user;
obtaining an advertisement to be displayed for the given user from an advertisement database;
altering a context of the advertisement based on the archetype identification information in the profile of the given user; and
communicating the altered advertisement to the given user.

2. The method of claim 1 wherein the profile further includes preference information for the given user and wherein the step of obtaining the information content is accomplished based at least in part upon the preference information.

3. The method of claim 2 wherein the archetype identification information in the profile is developed based on an analysis of a context of interactions of the given user with a website on which the advertisement is to be displayed.

4. The method of claim 3 wherein the context of interactions of the given user includes timing of responses, patterns of access and response parametrics about how the given user has interacted with the website that is separate from information the given user has supplied to or requested from the website.

5. The method of claim 1 wherein the method is performed by a first server on the Internet and the advertisement database is maintained on a second host on the Internet and wherein the step of obtaining the advertisement is accomplished by requesting the advertisement from the second server.

6. The method of claim 5 wherein the archetype identification information in the profile is developed based on an analysis of a context of interactions of the given user with the first server.

7. The method of claim 6 wherein the context of interactions of the given user includes timing of responses, patterns of access and response parametrics about how the given user has interacted with the first server that is separate from information the given user has supplied to or requested from the first server.

8. The method of claim 1 wherein the context of the advertisement that is altered is selected from the set consisting of color, texture, font, background, voice, pacing, or any combination thereof.
